(19) United States
(12) Patent Application Publication
(10) Pub. No.: US 2006/0200651 A1
(43) Pub. Date: Sep. 7, 2006

(54) Method and apparatus for power reduction utilizing heterogeneously-multi-pipelined processor

(76) Inventors: Thomas K. Collopy, Cary, NC (US); Thomas Andrew Sartorius, Raleigh, NC (US)

Correspondence Address: QUALCOMM INCORPORATED, 5775 MOREHOUSE DR., SAN DIEGO, CA, 92121, US

(21) Appl. No.: 11/072,667

(22) Filed: Mar. 3, 2005

(51) Int. Cl. G06F 15/00

(52) U.S. Cl. 712/220

(57) ABSTRACT

A processor includes a common instruction decode front end, e.g. fetch and decode stages, and a heterogeneous set of processing pipelines. A lower performance pipeline has fewer stages and may utilize lower speed/power circuitry. A higher performance pipeline has more stages and utilizes faster circuitry. The pipelines share other processor resources, such as an instruction cache, a register file stack, a data cache, a memory interface, and other architected registers within the system. In disclosed examples, the processor is controlled such that processes requiring higher performance run in the higher performance pipeline, whereas those requiring lower performance utilize the lower performance pipeline, in at least some instances while the higher performance pipeline is effectively inactive or even shut-off to minimize power consumption. The configuration of the processor at any given time, that is to say the pipeline(s) currently operating, may be controlled via several different techniques.

### TECHNICAL FIELD

The present subject matter relates to techniques and processor architectures to efficiently provide pipelined processing with reduced power consumption when processing functions require lower processing capabilities.

### BACKGROUND

Integrated processors, such as microprocessors and digital signal processors, commonly utilize a pipelined processing architecture. A processing pipeline essentially consists of a series of processing stages, each of which performs a specific function and passes the results to the next stage of the pipeline. A simple example of a pipeline might include a fetch stage to fetch an instruction, a decode stage to decode the instruction obtained by the fetch stage, a readout stage to read or obtain operand data and an execution stage to execute the decoded instruction. A typical execution stage might include an arithmetic logic unit (ALU). A write-back stage places the result of execution in a register or memory for later use. Instructions move through the pipeline in series.

During a given processing cycle, each stage is performing its individual function based on one of the series of instructions, so that the pipeline concurrently processes a number of instructions corresponding to the number of stages. As intended speed of operation increases, manufactures increase the number of individual stages of the pipeline, so that more instructions are processed during each cycle. Essentially, the five main functions outlined above are broken down into smaller tasks and distributed over more stages. Also, faster transistors or stage architectures may be used. However, increasing the number of stages increases power consumption. Faster transistors or stage architectures often further increase power consumption.

Many functions or applications of the processor, particularly in portable or low power devices, do not require the full processing capability of the pipeline or require the full processing capability only for a very limited time. Sated another way, processors designed for higher performance applications must use faster circuits and deeper pipelines than processors designed for lower performance applications, however, even the higher performance processors often execute applications or portions thereof that require only the lower performance processing capabilities. The higher performance processor pipeline consumes more power, even when executing the lower performance requirements.

A need has been recognized for a technique for a higher performance processing system to operate in a lower performance mode, e.g. while running a lower performance application, while dissipating less power than required for full high performance operations. Preferably, the low performance operation would utilize power comparable to that of a low performance processor.

Some architectures intended to address this need have utilized two separate central processing units, one for high performance and one for low performance, with selection based on the requirements of a particular application or process. Other suggested architectures have used parallel central processing units of equal performance (but less individual performance than full high performance) and aggregated their use/operation as higher performance becomes necessary, in a multi-processing scheme. Any use of two or more complete central processing units significantly complicates the programming task, as the programmer must write separate programs for each central processing unit and include instructions in each separate program for necessary communications and coordination between the central processing units when the different applications must interact. The use of two or more central processing units also increases the system complexity and cost. For example, two central processing units often include at least some duplicate circuits, such as the instruction fetch and decode circuitry, registers files, caches, etc. Also, the interconnection of the separate units can complicate the chip circuitry layout.

Hence, a need exists for a more effective technique to allow a signal processor to run processes at different performance levels while consuming different amounts for power, e.g. so that in a lower performance mode the power dissipation is lower and may even be comparable to that of a lower performance processor.

### SUMMARY

The teachings herein allow a pipelined processor to operate in a low performance mode at a reduced power level, by selective processing of instructions through two or more heterogeneous pipelines. The processing pipelines are heterogeneous or unbalanced, in that the depth or number of stages in each pipeline is substantially different.

A method of pipeline processing of instructions for a central processing unit involves sequentially decoding each instruction in a stream of instructions and selectively supplying decoded instructions to two processing pipelines, for multi-stage processing. First instructions are supplied to a first processing pipeline having a first number of one or more stages; and second instructions are supplied to a second processing pipeline of a second number of stages. The second pipeline is longer in that it includes a higher number of stages than the first pipeline, and therefore performance of the second processing pipeline is higher than the performance of the first processing pipeline.

In the examples discussed in detail below, the second decoded instructions, that is to say those instructions selectively applied to the second processing pipeline, have higher performance requirements than the first decoded instructions. During the performance of at least some of the functions based on the first decoded instructions through the stages of the first processing pipeline, the second processing pipeline does not concurrently perform any of the functions based on the second decoded instructions. Consequently, at such times, the second processing pipeline having the higher performance is not consuming as much power, and in some examples may be entirely cut-off from power. Because of its fewer stages, and because it typically runs at a slower rate and may utilize lower power circuitry, the first processing pipeline consumes less power than the second processing pipeline. Except for differences in performance and power consumption, both pipelines provide similar overall processing. Via a common front end, it is possible to feed one unified program stream and segregate instructions internally based on performance requirements. Hence, the application drafter need not specifically tailor the software to different capabilities of two separate processors.

A number of algorithms are disclosed for selectively supplying instructions to the processing pipelines. For example, the selections may be based on the performance requirements of the first and second decoded instructions, e.g. on an instruction by instruction basis or based on application level performance requirements. In another example, the selections are based on addresses of instructions in first and second ranges.

A processor, for example, for implementing methods of processing like those outlined above, includes a common instruction memory for storing processing instructions and a heterogeneous set of at least two processing pipelines. Means are provided for segregating a stream of the processing instructions obtained from the common instruction memory based on performance requirements. This element supplies processing instructions requiring lower performance to a lower performance one of the processing pipelines and supplies processing instructions requiring higher performance to a higher performance one of the processing pipelines.

In a disclosed example, the set of pipelines includes a first processing pipeline of a first number of one or more stages and a second processing pipeline of a second number of stages greater than the first number of stages. The second processing pipeline provides higher performance than the first processing pipeline. Typically, the second processing pipeline operates at a higher clock rate, performs less functions per clock cycle but has more stages and uses more processing cycles (each of which is shorter), and thus draws more power than does the first processing pipeline. A common front end obtains the processing instructions from the common instruction memory and selectively supplies processing instructions to the two processing pipelines. In the examples, the common front end includes a fetch stage and a decode stage. The fetch stage is coupled to the common instruction memory, and the logic of that stage fetches the processing instructions from memory. The decode stage decodes the fetched processing instructions and supplies decoded processing instructions to the appropriate processing pipelines.

Additional objects, advantages and novel features will be set forth in part in the description which follows, and in part will become apparent to those skilled in the art upon examination of the following and the accompanying drawings or may be learned by production or operation of the examples. The objects and advantages of the present teachings may be realized and attained by practice or use of the methodologies, instrumentalities and combinations particularly pointed out in the appended claims.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a functional block diagram of a central processing unit implementing a common front end and a heterogeneous set of processing pipelines.

FIG. 2 is a logical/flow diagram useful in explaining a first technique for segregating instructions for distribution among the pipelines in a system like that of FIG. 1.

FIG. 3 is a logical/flow diagram useful in explaining a second technique for segregating instructions for distribution among the pipelines in a system like that of FIG. 1.

FIG. 4 is a logical/flow diagram useful in explaining a third technique for segregating instructions for distribution among the pipelines in a system like that of FIG. 1.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

An exemplary processor, for use as a central processing unit or digital signal processor, includes a common instruction decode front end, e.g. fetch and decode stages. The processor, however, includes at least two separate execution pipelines. A lower performance pipeline dissipates relatively little power. The lower performance pipeline has fewer stages and may utilize lower speed circuitry that draws less power. A higher performance pipeline has more stages and may utilize faster circuitry. The lower performance pipeline may be clocked at a frequency lower than the high performance pipeline. Although the higher performance pipeline draws more power, its operation may be limited to times when at least some applications or process functions require the higher performance.

The processor is controlled such that processes requiring higher performance run in the higher performance pipeline, whereas those requiring lower performance utilize the lower performance pipeline, in at least some instances while the higher performance pipeline is effectively shut-off to minimize power consumption. The configuration of the processor at any given time, that is to say the pipeline(s) currently operating, may be controlled via several different techniques. Examples of such control include software control, wherein the software itself indicates the relative performance requirements and thus dictates which pipeline(s) should process the particular software. The selection may also be dictated by the memory location(s) from which the particular instructions are obtained, e.g. such that instructions from some locations go to the lower performance pipeline and instructions from other locations go to the higher performance pipeline. Other approaches might utilize a hardware mechanism to adaptively or dynamically detect processing requirements and direct instructions, applications or functions to the appropriate pipeline(s).

In the examples, the processor utilizes at least two parallel execution pipelines, wherein the pipelines are heterogeneous. The pipelines share other processor resources, such as any one or more of the following: the fetch and decode stages of the front end, an instruction cache, a register file stack, a data cache, a memory interface, and other architected registers within the system.

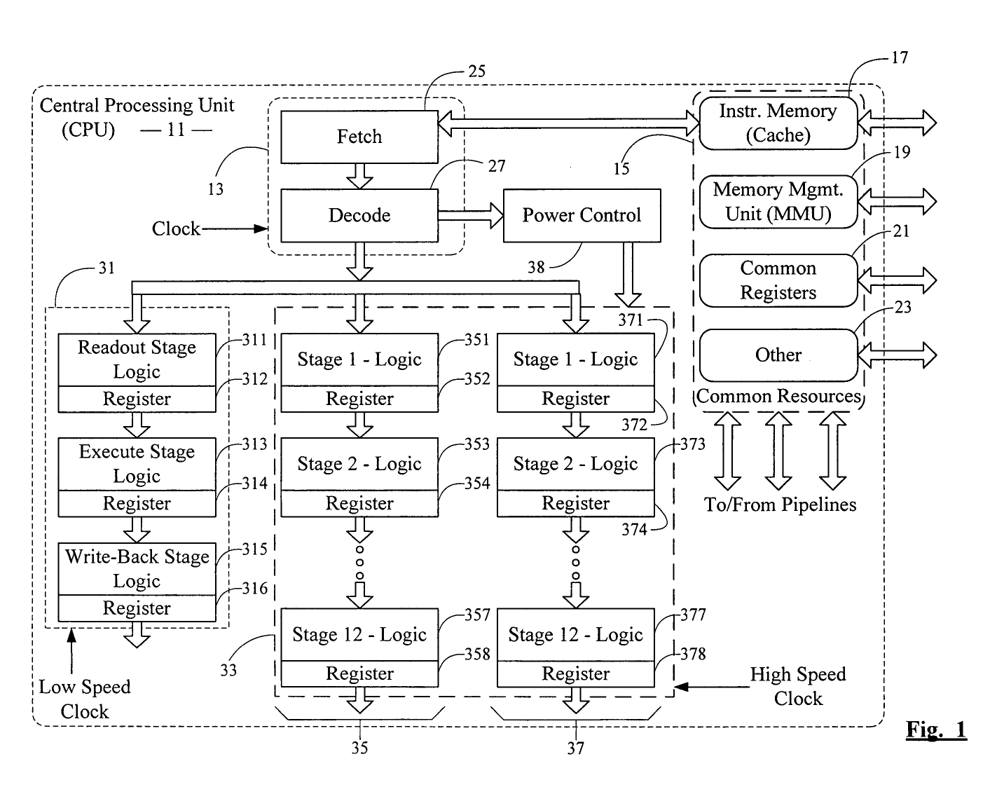

Reference now is made in detail to the examples illustrated in the accompanying drawings and discussed below. FIG. 1 illustrates a simplified example of a processor architecture serving as a central processing unit (CPU) 11. The processor/CPU 11 uses heterogeneous parallel pipeline processing, wherein one pipeline provides lower performance for low performance/low power operations. One or more other pipelines provide higher performance.

A “pipeline” can include as few as one stage, although typically it includes a plurality of stages. In a simple form, a processor pipeline typically includes pipeline stages for five major functions. The first stage of the pipeline is an instruction fetch stage, which obtains instructions for processing by later stages. The fetch stage supplies each instruction to a decode stage. Logic of the instruction decode stage decodes the received instruction bytes and supplies the result to the next stage of the pipeline. The function of the next stage is data access or readout. Logic of the readout stage accesses memory or other resources to obtain operand data for processing in accord with the instruction. The instruction and operand data are passed to the execution stage, which executes the particular instruction on the retrieved data and produces a result. A typical execution stage may implement an arithmetic logic unit (ALU). The fifth stage writes the results of execution back to memory.

In advanced pipeline architectures, each of these five stage functions is sub-divided and implemented in multiple stages. Super-scalar designs utilize two or more pipelines of substantially the same depth operating concurrently in parallel. An example of such a super-scalar processor might use two parallel pipelines, each comprising fourteen stages.

The exemplary CPU 11 includes a common front end 13 and a number common resources 15. The common resources 15 include an instruction memory 17, such as an instruction cache, which provides a unified instruction stream for the pipelines of the processor 11. As discussed more below, the unified instruction stream flows to the common front end 13, for distribution of instructions among the pipelines. The common resources 15 include a number of resources 19-23 that are available for use by all of the pipelines. The examples of such resources include a memory management unit (MMU) 19 for accessing external memory and a stack or file of common use registers 21, although there may be variety of other common resources 23. Those skilled in the art will recognize that the resources are listed as common resources above only by way of example. No one of these resources necessarily needs to be common. For example, the present teachings are equally applicable to processors having a common register file and to processors that do not use a common register file.

Continuing with the illustrated example, the common front end 1 includes a ‘Fetch’ stage 25, for fetching instructions in sequence from the instruction memory 17. Sequentially, the Fetch stage 25 feeds each newly obtained instruction to a Decode stage 27. As part of its decoding function, Decode stage 27 routes or switches each decoded instructions to one of the pipelines.

Although not shown separately, the Fetch stage 25 typically comprises a state machine or the like implementing the fetch logic and an associated register for passing a fetched instruction to the Decode stage 27. The Fetch stage logic initially attempts to fetch the next addressed instruction from the lowest level instruction memory, in this case, an instruction cache 17. If the instruction is not yet in the cache 17, the logic of the Fetch stage 25 will fetch the instruction into the cache 17 from other resources, such as a level two (L2) cache or main memory, accessed via the memory management unit 19. Once loaded in the cache 17, the logic of the Fetch stage 25 fetches the instruction from the cache 17 and supplies the instruction to the Decode stage 27. The instruction will then be available in the cache 17, if needed subsequently. Although not separately shown, the instruction cache 17 will often provide or have associated therewith a branch target address cache (BTAC) for caching of target addresses for branches taken during processing of branch type instructions by the pipeline processor 11, in a manner analogous to the operation of the instruction case 17. Those skilled in the art will recognize that the Fetch stage 25 and/or the Decode stage 27 may be broken down into sub-stages, for increased pipelining.

The CPU 11 includes a low performance pipeline processing section 31 and a high-performance pipeline processing section 33. The two sections 31 and 33 are heterogeneous or unbalanced, in that the depth or number of stages in each pipeline is substantially different. The high performance section 33 typically includes more stages than in the pipeline forming the low performance section 31, and in the example, the high performance section 31 includes two (or more) parallel pipelines each of which has the same number of stages and is substantially deeper than the pipeline of the low performance section 31. Since the Fetch and Decode stages are implemented in the common front end 13, the low performance pipeline could consist of only a single stage. Typically, the lower performance pipeline includes two or more stages. The low performance pipeline section 31 could include multiple pipelines in parallel, but to minimize power consumption and complexity, the exemplary architecture utilizes a single three stage pipeline in the low performance section 31.

For each instruction received from the Fetch stage 25, the Decode stage 27 decodes the instruction bytes and supplies the result to the next stage of the pipeline. Although not shown separately, the Decode stage 27 typically comprises a state machine or the like implementing the decode logic and an associated register for passing a decoded instruction to the logic of the next stage. Since the processor 11 includes multiple pipelines, the Decode stage logic also determines the pipeline that should receive each instruction and routes each decoded instruction accordingly. For example, the Decode stage 27 may include two or more registers, one for each pipeline, and the logic will load each decoded instruction into the appropriate register based on its determination of which pipeline is to process the particular instruction. Of course, an instruction dispatch unit or another routing or switching mechanism may be implemented in the Decode stage 27 or between that stage and the subsequent pipeline processing stages 31, 33 of the CPU 11.

Each pipeline stage includes logic for performing the respective function associated with the particular stage and a register for capturing the result of the stage processing for transfer to the next successive stage of the pipeline. Consider first the lower performance pipeline 31. As noted, the common front end 13 implements the first two stages of a typical pipeline, Fetch and Decode. In its simplest form, the pipeline 31 could implement as few as one stage, but in the example it implements three stages, for the remaining major functions of a basic pipeline, that is to say Readout, Execution and Write-back. The pipeline 31 may consist of somewhat more processing stages, to allow some breakdown of the functions for somewhat improved performance.

A decoded instruction from the Decode stage 27 is applied first to the logic 311, that is to say the readout logic 311, which accesses common memory or other common resources (19-23) to obtain operand data for processing in accord with the instruction. The readout logic 311 places the instruction and operand data in an associated register 312 for passage to the logic of the next stage. In the example, the next stage is an arithmetic logic unit (ALU) serving as the execute logic 313 of the execution stage. The ALU execute logic 313 executes the particular instruction on the retrieved data, produces a result and loads the result in a register 314. The logic 315 and associated register 316 of the final stage function to write the results of execution back to memory.

During each processing cycle, each logic performs its processing on the information supplied from the register of the preceding stage. As an instruction moves from one stage to the next, the preceding stage obtains and processes a new instruction. At any given time during processing through the pipeline 31, five stages 25, 27, 311, 313 and 315 are concurrently performing their assigned tasks with respect to five successive instructions.

The pipeline 31 is relatively low in performance in that it has a relatively small number of stages, just three in our example. The clock speed of the pipeline 31 is relatively low, e.g. 100 MHz. Also, each stage of the pipeline 31 may use relatively low power circuits, e.g. in view of the low clock speed requirements. By contrast, the higher performance processing pipeline section 33 utilizes more stages, the processing pipeline 33 is clocked at a higher rate (e.g. 1 GHz), and each stage of that pipeline 33 uses faster circuitry that typically requires more power. Those skilled in the art will understand that the different clock rates are examples only. For example, the present teachings are applicable to implementations in which both pipelines are clocked at the same frequency.

Continuing with the illustrated example, the front end 25 will be designed to compensate for clock rate differences in its operation, with regard to instructions intended for the different pipelines 31 and 33. Several different techniques may be used, and typically one is chosen to optimally support the particular algorithm that the front end 25 implements to select between the pipelines 31 and 33. For example, if the front end 25 selectively feeds only one or the other of the pipelines for long intervals, then the front end clock rate may be selectively set to each of the two pipeline rates, to always match the rate of the currently active one of the pipelines 31 and 33.

In the example, the processing pipeline section 33 uses a super-scalar architecture, which includes multiple parallel pipelines of substantially equal depth, represented by two individual parallel pipelines 35 and 37. The pipeline 35 is a twelve stage pipeline in this example, although the pipeline may have fewer or more stages depending on performance requirements established for the particular section 33. Like the pipeline 35, the pipeline 37 is a twelve stage pipeline, although the pipeline may have fewer or more stages depending on performance requirements. These two pipelines operate concurrently in parallel, in that two sets of instructions move through and are processed by the stages of the two pipelines substantially at the same time. Each of these two pipelines has access to data in main memory, via the MMU 19 and may use other common resources as needed, such as the registers 21 etc.

Consider first the pipeline 35. A decoded instruction from the Decode stage 27 is applied first to the stage 1 logic 351. The logic 351 processes the instruction in accord with its logic design. The processing may entail accessing other data via one or more of the common resources 15 or some task related to such a readout function. When complete, the processing result appears in register 352 and is passed to the next stage. In the next processing cycle, the logic 353 of the second stage performs its processing on the result from the first stage register 352, and loads its result into a register 354 for passage to the third stage, and this continues until processing by the twelfth stage logic 357, and after processing by that logic, the final result appears in register 358 for output, typically for write-back to or via one of the common resources 15. Together, several of the stages perform a function analogous to readout. Similarly, several stages together essentially execute each instruction; and one or more stages near the bottom of the pipeline write-back the results to registers and/or to memory.

Of course, during each successive processing cycle during operation of the higher performance processing pipeline 33, the Decode stage 27 supplies a new decoded instruction to the first stage logic 351 for processing. As a result, during any given processing cycle, each stage of the pipeline 35 is performing its assigned processing task concurrently with processing by the other stages of the pipeline 35.

Also during each cycle of operation of the higher performance pipeline section 33, the Decode stage 27 supplies a decoded instruction to the stage 1 logic 371 of parallel pipeline 37. The logic 371 processes the instruction in accord with its logic design. The processing may entail accessing other data via one or more of the common resources 15 or some task related to such a readout function. When complete, the processing result appears in register 372 and is passed to the next stage. In the next processing cycle, the logic 373 of the second stage performs its processing on the result from the first stage register 372, and loads its result into a register 374 for passage to the third stage, and this continues until processing by the twelfth stage logic 377, and after processing by that logic, the final result appears in register 378 for output, typically for write-back to or via one of the common resources 15. Together, several of the stages perform a function analogous to readout. Similarly, several stages together essentially execute each instruction; and one or more stages near the bottom of the pipeline write-back the results to registers and/or to memory.

Of course, during each successive processing cycle during operation of the higher performance processing pipeline 33, the Decode stage 27 supplies a new decoded instruction to the first stage logic 371 for processing. As a result, during any given processing cycle, each stage of the pipeline 37 is performing its assigned processing task concurrently with processing by the other stages of the pipeline 37.

In this manner, the two pipelines 35 and 37 operate concurrently in parallel, during the processing operations of the higher performance pipeline section 33. These operations may entail some exchange of information between the stages of the two pipelines.

Overall, the processing functions performed by the processing pipeline section 31 may be substantially similar or duplicative of those performed by the processing pipeline section 33. Stated another way, the combination of the front end 13 with the low performance section 31 essentially provides a full single-scalar pipeline processor for implementing low performance processing functions or applications of the CPU 11. Similarly, the combination of the front end 13 with the high performance processing pipeline 33 essentially provides a full super-scalar pipeline processor for implementing high performance processing functions or applications of the CPU 13. Due to the higher number of stages and the faster circuitry used to construct the stages, the pipeline section 33 can execute instructions or perform operations at a much higher rate.

Because each section 31, 33 can function with the front end 13 as a full pipeline processor, it is possible to write programming in a unified manner, without advance knowledge or determination of which pipeline section 31 or 33 must execute a particular instruction or sub-routine. There is no need to deliberately write different programs for different resources in different central processing units. To the contrary, a single stream of instructions can be split between the processing pipelines based on requirements of performance versus power consumption. If an application requires higher performance and/or merits higher power consumption, then the instructions for that application are passed through the high performance pipeline section 33. If not, then processing through the lower performance pipeline 31 should suffice.

The processor 11 has particular advantages when utilized as the CPU of a handheld or portable device that often operates on a limited power supply, typically a battery type supply. Examples of such applications include cellular telephones, handheld computers, personal digital assistants (PDAs), and handheld terminal devices like the BlackBerry™. When the CPU 11 is used in such devices, the low performance pipeline 31 runs applications or instructions with lower performance requirements, such as background monitoring of status and communications, telephone communications, e-mail, etc. Device applications requiring higher performance, for example for related hi-resolution graphics rendering, such as video games or the like, would run on the higher performance pipeline section 33.

When there are no high performance functions needed, for example, when a device incorporating the CPU 11 is running only a low performance/low power application, the high performance section 33 is not in use, and power consumption is reduced. The front end 25 may run at the low clock rate. During operation of the high performance section 33, that section may run all currently executing applications, in which case, the low performance section 31 may be off to conserve power. The front end 25 would run at the higher clock rate.

It is also possible to continue to run the low performance pipeline 31 during operation of the high performance pipeline 33, for example, to perform selected low performance functions in the background. In a cellular telephone type application of the processor 11, for example, the telephone application might run on the low performance section 31. Applications such as games that require video processing utilize the high performance section 33. During a game, which is run in high performance section 33, the telephone application may continue to run in low performance section 31, e.g. while the station effectively listens for an incoming call. The front end 25 would keep track of the intended pipeline destination of each fetched instruction and adapt its dispatch function to the clock rate of the pipeline 31 or 33 intended to process each particular instruction.

There are several ways to implement power saving in a system such as that shown in FIG. 1. For example, when running only the lower performance processing pipeline 33, the higher performance processing pipeline 31 is inoperative; and as a result, the stages of section 33 do not dynamically draw operational power. This reduces dynamic power consumption. To reduce leakage, the transistors of the stages of section 31 may be designed with relatively high gate threshold voltages. Alternatively, the CPU 11 may include a power control 38 for the higher performance processing pipeline section 31. The control 38 turns on power to the section 33, when the Decode stage 27 has instructions for processing in the pipeline(s) of section 33. When all processing is to be performed in the lower performance processing pipeline 31, the control 38 cuts off a connection to one of the power terminals (supply or ground) with respect to the stages of section 33. The cut-off eliminates leakage through the circuitry of processing section 33.

In the illustrated example with the power control 38, power to the lower performance processing pipeline 31 is always on, e.g. so that the pipeline 31 can perform some instruction execution even while the higher performance processing pipeline 33 is operational. In this way, the pipeline 31 remains available to run background applications and/or run some instructions in support of applications running mainly through the higher performance processing pipeline 33. In an implementation in which all processing shifts to the higher performance processing pipeline 33 while that pipeline is operational, there may be an additional power control (not shown) to cut-off power to the lower performance processing pipeline 31 while it is not in use.

There are a number of ways that the front end 13 can dynamically adapt to the differences in the rates of operations of the two pipelines 31 and 33, even if the two pipelines may operate concurrently under at least some conditions. In one approach, for each instruction delivered by the front end 25, the front end 25 considers a “ready” signal delivered by the particular pipeline 31 or 33 to which the instruction is to be delivered. If the particular pipeline 31 or 33 is running at a slower frequency than the front end 25 (at a front end to pipeline clock ratio of N:1) then this “ready” signal will only be active at most once every N cycles. The front end dispatches the next decoded instruction to the particular pipeline in response to the ready signal for that pipeline 31 or 33. In another approach, the front end 25 itself is responsible for keeping track of when it has sent an instruction to each of the pipes, and keeping a “count” of the cycles needed between the delivery of one instruction and the next, according to its knowledge of the relative frequencies of the two pipelines 31 and 33.

As indicated above, the “asynchronous” interface between the front end 25 and each pipeline 31, 33 can be operated according to any of the multitude of “frequency synchronization approaches” that would be known to one skilled in the art of interfacing logic operating in two different frequency domains. The interface can be fully asynchronous (no relationship between the two frequencies), or isochronous (some integral relationship between the two frequencies, such as 3:2). Regardless of the approach, the front end 25 can simultaneously interface between both the lower performance pipeline 31 and the higher performance pipeline 33, in the event that the front end 25 is capable of multi-threading. Each interface is according to the frequency relationship, and instructions destined for a given pipeline 31 or 33 are clocked according to that pipeline's frequency synchronization mechanism.

The solution outlined above resembles a super-scalar pipeline processor design, in that it includes multiple pipelines implemented in parallel within a single processor or CPU 11. The difference, however, is that rather than a single overall process utilizing all of the execution pipelines in parallel, as in the super-scalar, the exemplary processor 11 restricts usage to the particular pipelines designed for delivery of the performance necessary for the processes in the particular category (e.g. low or high). Also, typical super-scalar processor architectures utilize a collection of pipelines that are relatively balanced in terms of depth. By contrast, the pipelines 31 and 33 in the example are “unbalanced” (heterogeneous) as required to separately satisfy the conflicting requirements of high performance and low power.

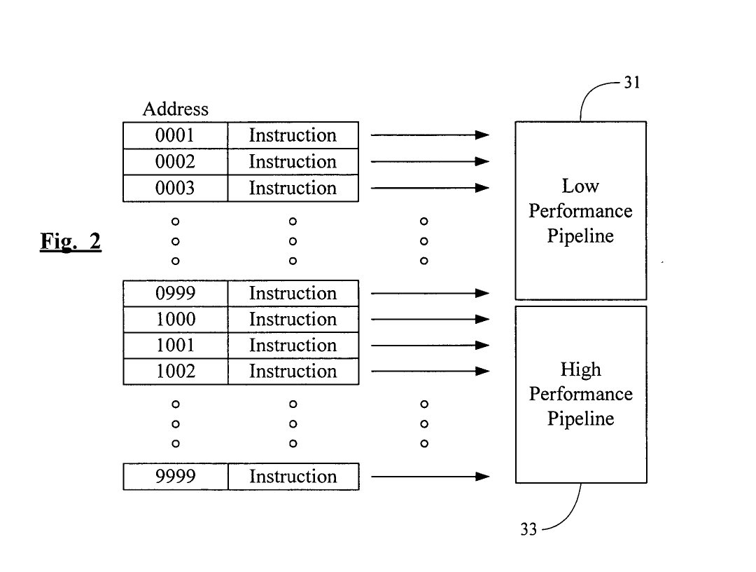

A variety of different techniques may be used to determine which instructions to direct to each processing pipeline or section 31, 33. It may be helpful to consider some logical flows, as shown in FIGS. 2-4, by way of examples.

A first exemplary instruction dispatching approach utilizes addresses of the instructions to determine which instructions to send to each pipeline. In the example of FIG. 2, a range of addresses is assigned to the low performance processing pipeline 31, and a range of addresses is assigned to the higher performance processing pipeline 33. When application instructions are written and stored in memory, they are stored in areas of memory based on the appropriate ranges of instruction addresses.

For discussion purposes, assume that address range 0001 to 0999 relates to low performance instructions. Instructions stored in main memory in locations corresponding to those addresses are instructions of applications having lower performance requirements. When the instructions of the lower performance applications are loaded into the instruction cache 17, the addresses are loaded as well. When the front end 13 fetches and decodes the instructions from the cache 17, the decode stage 27 dispatches instructions identified by any address in the range from 0001 to 0999 to the lower performance pipeline 31. When such instructions are being fetched, decoded and processed through the lower performance pipeline 31, the higher performance processing pipeline 33 may be inactive or even disconnected from power, to reduce dynamic and/or leakage power consumption by the CPU 11.

However, when the front end 13 fetches and decodes the instructions, the decode stage 27 dispatches instructions identified by any address in the range from 1000 to 9999 to the higher performance pipeline 33. When those instructions are being fetched, decoded and processed through the higher performance pipeline 33, at least the processing pipeline 33 is active and drawing full power, although the pipeline 31 may also be operational.

In an example of the type represented by the flow of FIG. 2, the logic of the Decode stage 27 determines where to direct decoded instructions, based on the instruction addresses. Of course, this dispatch logic may be implemented in a separate stage. Those skilled in the art will recognize that the address ranges given are examples only. Other addressing schemes will be used in actual processors, and a variety of different range schemes may be used to effectively allocate regions of memory to the heterogeneous processing pipelines 31 and 33. For example, the assigned ranges or memory locations for each pipeline may or may not be continuous or contiguous.

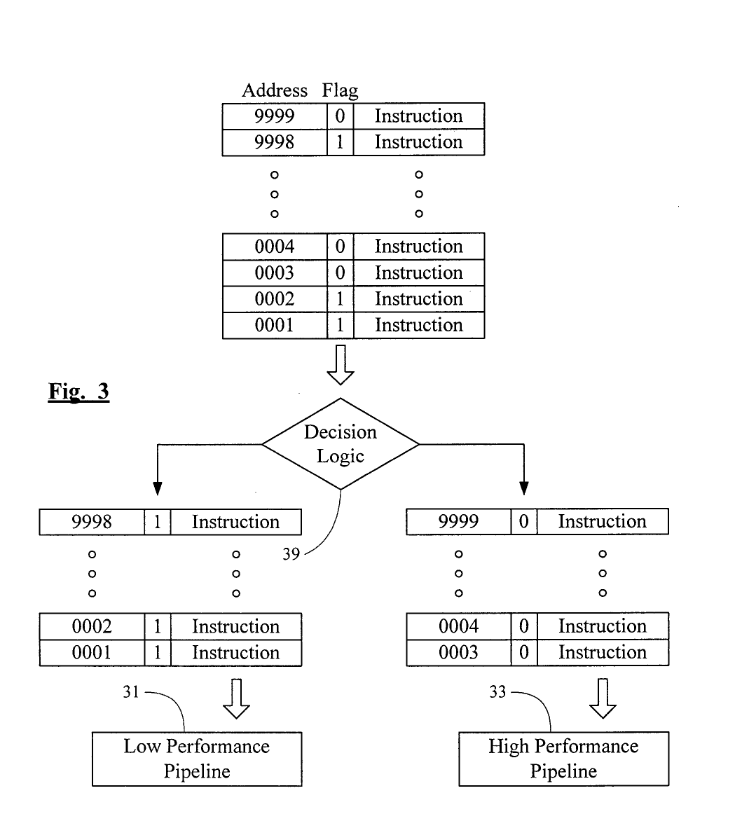

The flow illustrated in FIG. 3 represents a technique in which a decision is made by logic 39 based on a flag associated with each instruction. The decision may be implemented in the logic of the Decode stage 27 or in a dispatch stage between stage 27 and the pipeline 31, 33. In this example, a one-bit flag is set in memory in association with each of the instructions for the CPU 11. The flag has a 0 state for any instruction having a high performance processing requirement. The flag has a 1 state for any instruction having a low performance processing requirement (or not having a high-performance processing requirement). Of course, these flag states are only examples.

As each instruction in the stream fetched from the memory 17 reaches the logic 39, the logic examines the flag. If the flag has a 0 state, the logic dispatches the instruction to the higher performance processing pipeline 33. If the flag has a 1 state, the logic dispatches the instruction to the lower performance processing pipeline 31. In the example, the first two instructions (0001, and 0002) are low performance instructions (1 state of the flag for each), and the decision logic 39 routes those instructions to the lower performance processing pipeline 31. The next two instructions (0003, and 0004) are high performance instructions (0 state of the flag for each), and the decision logic 39 routes those instructions to the higher performance processing pipeline 33.

This alternate routing or dispatching of the instructions continues throughout the fetching and decoding of instructions in the stream from the memory 17. In the example, the next to last instruction in the sequence (9998) is a low performance instruction (1 state of the flag), and the decision logic 39 routes the instruction to the lower performance processing pipeline 31. The last instruction in the sequence (9999) is a high performance instruction (0 state of the flag), and the decision logic 39 routes the instruction to the higher performance processing pipeline 33. Further processing wraps around to the 0001 first instruction and continues through the sequence again. Although not shown, the instruction processing will likely branch from time to time, however, the decision logic 39 will continue to dispatch each instruction to the appropriate pipeline based on the state of the performance requirements flag. Again, the address numbering from 0001 to 9999 is representative only, and the scheme can and will be readily adapted to the addressing schemes utilized with particular actual processors.

The dispatch techniques of the type represented by FIG. 3 dispatch each individual instruction based on the associated flag. This technique may be useful, for example, where the two pipelines at times run concurrently for some periods of time. While the higher performance processing pipeline 33 is running, the lower performance processing pipeline 31 may be running certain support or background applications. Of course, at times when only low performance instructions are being executed, the higher performance processing pipeline 33 will be inactive and the CPU 11 will draw less power, as discussed earlier in relation to FIG. 1.

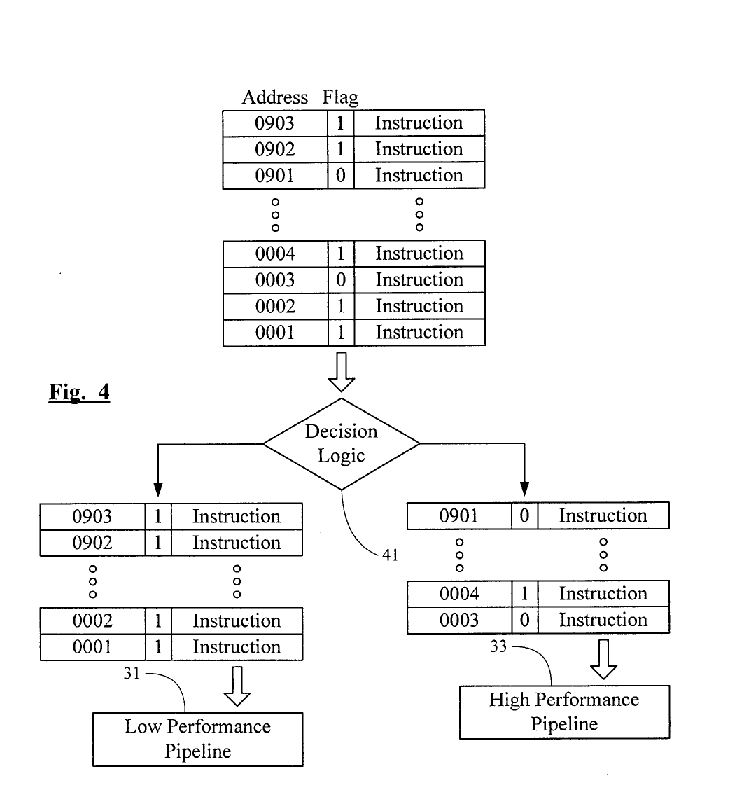

The flow illustrated in FIG. 4 exemplifies another technique utilizing a flag. This technique is similar to that of FIG. 3, but implements somewhat different decision logic at 41. Again, the address numbering is used only for a simple example and discussion purposes. When there is no high performance application running, all instructions received by the logic 41 have the low performance value (e.g. 1) set in the flag. In response, the logic 41 dispatches the decoded versions of those instructions (0001 and 0002 in the simple example) to the lower performance processing pipeline 31. The pipeline 33 is idle.

The decision logic 41 determines if processing of a high performance application has begun, based on receiving a start instruction (e.g. at 0003) with a high performance value (e.g. 0) set in the flag. So long as that application remains running, e.g. from instruction 0003 through instruction 0901, the logic 49 dispatches all decoded instruction to the higher performance processing pipeline 33. The lower performance processing pipeline 31 may be shut down and/or power to that pipeline cut-off during that period. The pipeline 33 processes both low performance and high performance instructions during this period. When the high performance application ends, at the 0901 instruction in the example, and a new instruction is fetched (e.g. 0902), the decision logic 41 resumes dispatching to the lower performance processing pipeline 31 and pipeline 33 becomes idle.

In the examples of FIGS. 2-4, the instruction dispatching and the associated processing status vis-à-vis the processing pipelines 31, 33 were based on information associated with the instructions maintained in or associated with the instruction memory, e.g. address values and/or flags. Other techniques may use combinations of such information or utilize totally different parameters to control the pipeline selections and states. For example, it is envisaged that logic could monitor the performance of the CPU 11 and dynamically adjust performance up or down when some metric reaches an appropriate threshold, e.g. to turn on the higher performance processing pipeline 33 when a time for response to a particular type of instruction gets too long and to turn off the pipeline 33 when the delay falls back below a threshold. If desired, separate hardware to perform monitoring and dynamic control may be provided. Those skilled in the art will understand that other control and/or instruction dispatch algorithms may be useful.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A method of pipeline processing of instructions for a central processing unit, comprising:
sequentially decoding each instruction in a stream of instructions;
selectively supplying first decoded instructions to a first processing pipeline of a first number of one or more stages;
performing a series of functions based on the first decoded instructions through the stages of the first processing pipeline;
selectively supplying second decoded instructions to a second processing pipeline of a second number of stages, wherein the second number of stages is higher than the first number of stages and performance of the second processing pipeline is higher than performance of the first processing pipeline; and
performing a series of functions based on the second decoded instructions through the stages of the second processing pipeline.

2. The method of claim 1, wherein during the performance of at least some of the functions based on the first decoded instructions through the stages of the first processing pipeline, the second processing pipeline does not concurrently perform any of the functions based on the second decoded instructions.

3. The method of claim 2, wherein the second decoded instructions have higher performance requirements than the first decoded instructions.

4. The method of claim 3, wherein the first processing pipeline consumes less power than the second processing pipeline.

5. The method of claim 4, further comprising cutting-off power to the second processing pipeline during performance of the at least some of the functions through the stages of the first processing pipeline.

6. The method of claim 4, wherein the selections are based on the performance requirements of the first and second decoded instructions.

7. The method of claim 4, wherein the selections are based on addresses of the first and second instructions being in first and second ranges, respectively.

8. A processor, comprising:
a common instruction memory for storing processing instructions;
a first processing pipeline comprising a first number of one or more stages;
a second processing pipeline comprising a second number of stages greater than the first number of stages, the second processing pipeline providing higher performance than the first processing pipeline; and
a common front end for obtaining the processing instructions from the common instruction memory and selectively supplying first ones of the processing instructions to the first processing pipeline and second ones of the processing instructions to the second processing pipeline.

9. The processor of claim 8, wherein:
the second processing pipeline operates at a higher clock rate than the first processing pipeline; and
the first processing pipeline draws less power than the second processing pipeline.

10. The processor of claim 8, wherein the common front end comprises:
a fetch stage for obtaining the processing instructions from the common instruction memory; and
a decode stage for decoding each of the obtained processing instructions and selectively supplying each of the decoded processing instructions to either the first processing pipeline or the second processing pipeline.

11. The processor of claim 8, wherein the common front end selects first processing instructions for supplying to the first processing pipeline and second processing instructions for supplying to the second processing pipeline based on relative performance requirements of the first and second processing instructions.

12. The processor of claim 8, wherein the first processing pipeline consists of a single scalar pipeline comprising a plurality of stages.

13. The processor of claim 8, wherein the second processing pipeline comprises two or more parallel multi-stage pipelines of similar depth, forming a super scalar pipeline.

14. The processor of claim 8, wherein:
a plurality of stages of the first processing pipeline are arranged to form a single scalar pipeline; and
the stages of the second processing pipeline are arranged to form a super-scalar pipeline comprising two or more parallel multi-stage pipelines of similar depth.

15. The processor of claim 14, wherein each of the two parallel pipelines comprises twelve stages.

16. The processor of claim 14, wherein the common front end comprises:
a fetch stage coupled to the common instruction memory for fetching the processing instructions; and
a decode stage for decoding the fetched processing instructions and supplying decoded first processing instructions to the first processing pipeline and supplying decoded second processing instructions to the two parallel pipelines.

17. The processor of claim 8, further comprising:
a memory management unit, commonly available to at least one stage of the first processing pipeline and to at least one stage of the second processing pipeline; and
a plurality of registers, commonly available to at least one stage of the first processing pipeline and to at least one stage of the second processing pipeline.

18. A processor, comprising:
a common instruction memory for storing processing instructions;
a heterogeneous set of at least two processing pipelines; and
means for segregating a stream of the processing instructions obtained from the common instruction memory based on performance requirements and supplying processing instructions requiring lower performance to a lower performance one of the processing pipelines and supplying processing instructions requiring higher performance to a higher performance one of the processing pipelines.

19. The processor as in claim 18, further comprising at least one resource commonly available to all of the heterogeneous processing pipelines.

20. The processor as in claim 19, wherein the at least one resource comprises:
a memory management unit providing access to a memory; and
a plurality of registers.

21. The processor as in claim 18, wherein the means for segregating comprises a common front end coupled between the common instruction memory and the heterogeneous set of processing pipelines.

22. The processor as in claim 21, wherein the common front end comprises:
a fetch stage coupled to the common instruction memory for fetching the processing instructions; and
a decode stage for decoding the fetched processing instructions and supplying decoded processing instructions requiring lower performance to the lower performance processing pipeline and supplying decoded processing instructions requiring higher performance to the higher performance processing pipeline.

23. The processor as in claim 18, wherein the lower performance processing pipeline draws less power than the higher performance processing pipeline.

24. A processor, comprising:
an instruction memory for storing processing instructions;
a heterogeneous set of processing pipelines, comprising:
(a) a first processing pipeline having a first plurality of stages to provide a first level of processing performance, and
(b) a second processing pipeline having a second plurality of stages greater in number than the first plurality of stages to provide a second level of processing performance higher than the first level of processing performance, wherein processing through the second processing pipeline consumes more power than processing through the first processing pipeline;
at least one common processing resource, available to both of the processing pipelines; and
a common front end, coupled between the instruction memory and the heterogeneous set of processing pipelines, the common front end, comprising:
(1) a fetch stage for fetching instructions from the instruction memory, and
(2) a decode stage for decoding the fetched instructions and selectively supplying first decoded instructions to the first processing pipeline and second decoded instructions to the second processing pipeline.

25. The processor of claim 24, wherein:
the stages of the first processing pipeline are arranged to form a single scalar pipeline; and
the stages of the second processing pipeline are arranged to form a super-scalar pipeline comprising two or more parallel multi-stage pipelines of similar depth.

26. The processor of claim 25, wherein:
the second decoded instructions comprise instructions requiring higher performance processing, and
the first decoded instructions consist of instructions requiring lower performance processing.
